(19) United States
(12) Patent Application Publication
(10) Pub. No.: US 2018/0284706 A1
(43) Pub. Date: Oct. 4, 2018

(54) GAS TURBINE DISPATCH OPTIMIZER

(71) Applicant: General Electric Company, New York, NY (US)

(72) Inventors: Olugbenga Anubi, Glenville, NY (US); Anup Menon, Guilderland, NY (US); Aditya Kumar, Schenectady, NY (US)

(21) Appl. No.: 15/476,084

(22) Filed: Mar. 31, 2017

(51) Int. Cl. G05B 19/042; F01D 21/00

(52) U.S. Cl. CPC G05B 19/042; F01D 21/003; F05D 2270/01; F05D 2220/32; G05B 2219/2639

(57) ABSTRACT

A dispatch optimization system leverages ambient and market forecast data as well as asset performance and parts-life models to generate recommended operating schedules for gas turbines or other power-generating plant assets that substantially maximize profit while satisfying parts-life constraints. The system generates operating profiles that balance optimal peak fire opportunities with optimal cold part-load opportunities within a maintenance interval or other operating horizon. To reduce the computational burden associated with generating the profit-maximizing operating profile, the system uses an estimated price of life value that accounts for creation (by cold part-loading) and exhaustion (by peak fire operation) of factored fired hour credits by means of computing the cost of such credits.

### TECHNICAL FIELD

The subject matter disclosed herein relates generally to power plant operation, and, more particularly, to long-term operation planning of power-generating plant assets.

### BACKGROUND

Many power plants employ gas turbines as a source of power to satisfy at least part of consumers' overall electrical demand. To ensure healthy long-term operation, plant facility owners typically schedule maintenance or service for their plant assets at regular intervals. Maintenance intervals for gas turbines are often defined in terms of factored fired hours, whereby maintenance is schedule for a set of gas turbines after the turbines have run for a defined number of factored fired hours (e.g., 32,000 factored fired hours) since the previous maintenance activity. The maintenance interval is typically defined based on an expected parts-life consumption for the gas turbine.

Plant operators sometimes peak-fire their gas turbines above their base capacity during peak demand periods. Peak-firing gas turbines above their base capacity produces extra power output when needed, but at the expense of faster parts-life consumption (e.g., extra factored fired hours). If gas turbines are peak-fired often within the maintenance interval (or maintenance life), the incremental parts-life consumption may cause the maintenance interval to be shortened. As a result, maintenance schedules are pulled in and extra customer service agreement charges may be incurred. Consideration of these extra maintenance costs, in terms of more frequent servicing of the gas turbines, can lead plant asset owners to exercise peak-fire mode more conservatively than necessary, which may result in missed revenue opportunity.

The above-described deficiencies of gas turbine operations are merely intended to provide an overview of some of the problems of current technology, and are not intended to be exhaustive. Other problems with the state of the art, and corresponding benefits of some of the various non-limiting embodiments described herein, may become further apparent upon review of the following detailed description.

### SUMMARY

The following presents a simplified summary of the disclosed subject matter in order to provide a basic understanding of some aspects of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

One or more embodiments provide a method, comprising selecting, by a system comprising at least one processor, a price of life value representing a cost per unit of consumed parts-life for one or more power-generating plant assets; determining, by the system for respective time units of a life cycle of the one or more power-generating plant assets, values of one or more operating variables that maximize or substantially maximize profit values based on the price of life value, the one or more operating variables comprising at least one of power output or operating temperature; determining, by the system, a predicted amount of consumed parts-life over the life cycle for the one or more power-generating plant assets based on the values of the one or more operating variables; and in response to determining that the predicted amount of consumed parts-life satisfies a defined constraint relative to a target life, generating, by the system, operating profile data for the one or more power-generating plant assets over the life cycle based on the values of the one or more operating variables for the respective time units.

Also, In one or more embodiments, a system is provided, comprising a profile generation component configured to: determine, for respective time units of a maintenance interval for one or more power-generating assets, first values of one or more operating variables that maximize or substantially maximize profit values based on an estimated price of life value representing a cost per unit of consumed parts-life for the one or more power-generating plant assets, in response to determining that an estimated number of units of parts-life consumed as a result of operating the one or more power-generating plant assets in accordance with the first values of the one or more operating variables satisfies a defined constraint relative to a target life, generate operating schedule data for the one or more power-generating plant assets based on the first values of the one or more operating variables, and in response to determining that the estimated number of units of parts-life consumed does not satisfy the defined constraint relative to the target life, modify the estimated price of life value to yield a modified price of life value and determine second values of the one or more operating variables that maximize or substantially maximize profit values based on the modified price of life value; and a user interface component configured to render the operating schedule data.

Also, according to one or more embodiments, a non-transitory computer-readable medium is provided having stored thereon instructions that, in response to execution, cause a safety relay device to perform operations, the operations comprising selecting a price of life value representing a cost per unit of consumed parts-life for one or more power-generating plant assets; determining, for respective time units of a life cycle of the one or more power-generating plant assets, values of one or more operating variables that maximize or substantially maximize profit values based on the price of life value, the one or more operating variables comprising at least one of power output or operating temperature; determining, for the respective time units, predicted numbers of units of parts-life for the one or more power-generating plant assets based on the values of the one or more operating variables; determining a predicted life of the one or more power-generating plant assets based on at least one of a sum or an integration of the predicted numbers of units of parts-life across the respective time units; and in response to determining that the predicted life satisfies a defined constraint relative to a target life, generating operating profile data for the one or more power-generating plant assets over the maintenance duration based on the values of the one or more operating variables for the respective time units.

To the accomplishment of the foregoing and related ends, the disclosed subject matter, then, comprises one or more of the features hereinafter more fully described. The following description and the annexed drawings set forth in detail certain illustrative aspects of the subject matter. However, these aspects are indicative of but a few of the various ways in which the principles of the subject matter can be employed. Other aspects, advantages, and novel features of the disclosed subject matter will become apparent from the following detailed description when considered in conjunction with the drawings. It will also be appreciated that the detailed description may include additional or alternative embodiments beyond those described in this summary.

### BRIEF DESCRIPTION OF DRAWINGS

FIG. 1 is a block diagram of an example 2×1 combined cycle plant comprising two gas turbines.

FIG. 2 an example graph of a steady state efficiency model for the combined cycle plant.

FIG. 3 is a generalized graph illustrating tradeoff between asset life and fuel efficiency.

FIG. 4 is a block diagram of an example dispatch optimization system for gas turbines or other power-generating plant assets.

FIG. 5 is a graph plotting the change in parts-life for a gas turbine or a set of gas turbines as a function of time over a total maintenance interval for an example operating scenario.

FIG. 6 is a block diagram illustrating example data inputs and outputs for a profile generation component of a dispatch optimization system.

FIG. 7 illustrates example tabular formats for pre-stored asset model data values.

FIG. 8 depicts graphs that plot example forecast data for predicted market conditions, predicted ambient conditions, and predicted load or electrical demand.

FIG. 9 is a computational block diagram illustrating iterative analysis performed on forecast data and asset model data by a profile generation component to produce a substantially optimized operating profile.

FIG. 10 is an example display format for an operating profile generated by a dispatch optimization system.

FIG. 11 is an example graphic that plots a recommended operating temperature defined by an operating profile over the duration of a maintenance interval together with predicted hourly electricity prices over the same maintenance interval.

FIG. 12 is a flowchart of an example methodology for generating a profit-maximizing operating schedule or profile for a plant asset.

FIG. 13 is an example computing environment.

FIG. 14 is an example networking environment.

### DETAILED DESCRIPTION

The subject disclosure is now described with reference to the drawings wherein like reference numerals are used to refer to like elements throughout. In the following description, for purposes of explanation, numerous specific details are set forth in order to provide a thorough understanding of the subject disclosure. It may be evident, however, that the subject disclosure may be practiced without these specific details. In other instances, well-known structures and devices are shown in block diagram form in order to facilitate describing the subject disclosure.

As used in the subject specification and drawings, the terms “object,” “module,” “interface,” “component,” “system,” “platform,” “engine,” “selector,” “manager,” “unit,” “store,” “network,” “generator” and the like are intended to refer to a computer-related entity or an entity related to, or that is part of, an operational machine or apparatus with a specific functionality; such entities can be either hardware, a combination of hardware and firmware, firmware, a combination of hardware and software, software, or software in execution. In addition, entities identified through the foregoing terms are herein generically referred to as “functional elements.” As an example, a component can be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer-readable storage media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As an example, a component can be an apparatus with specific functionality provided by mechanical parts operated by electric or electronic circuitry, which is operated by software, or firmware application executed by a processor, wherein the processor can be internal or external to the apparatus and executes at least a part of the software or firmware application. As another example, a component can be an apparatus that provides specific functionality through electronic components without mechanical parts, the electronic components can include a processor therein to execute software or firmware that confers at least in part the functionality of the electronic components. Interface(s) can include input/output (I/O) components as well as associated processor(s), application(s), or API (Application Program Interface) component(s). While examples presented hereinabove are directed to a component, the exemplified features or aspects also apply to object, module, interface, system, platform, engine, selector, manager, unit, store, network, and the like.

Power-generating plant assets, such as gas turbines, require regular maintenance to ensure safe, reliable, and efficient operation. Many plant asset owners contract the manufacturers of such plant assets to perform scheduled maintenance on the assets. In some cases, customer service agreements (CSAs) define a usage-based maintenance scheme whereby the manufacturer guarantees an operational duration for a given asset when subject to periodic maintenance. Under such contracts, the asset owner may pay the manufacturer a fee (e.g., a usage-based fee) for maintenance of the asset, and the manufacturer performs routine inspections, provides for repairs and part replacements when necessary, and performs other service functions required to keep the plant asset functioning within the agreed upon duration (or asset life). Since the costs of such repairs and replacements, as well as the frequency of inspections, depend on the operating history of the asset, the manufacturer and owner may agree upon a system of determining the operational impact on the useful life of the asset in connection with determining when maintenance should be performed.

One way of accounting for the operational impact on the asset is by tracking a parts-life metric called factored fired hours (FFHs). According to this approach, in an example applied to a gas turbine, every hour that the gas turbine is operated (or “fired”) up to its base capacity (that is, the rated capacity or base load of the gas turbine), one FFH is accrued for the gas turbine. An example gas turbine may comprise components designed to run for 32,000 FFH. If the gas turbine is operated up to its base capacity, each actual hour of operation translates to one FFH.

Gas turbines can also be operated in peak-fire mode, whereby the firing temperature (or operating temperature) is raised above the design value in order to produce a higher megawatt (MW) output relative to base-load operation. However, peak-firing also accelerates parts-life consumption. To reflect the faster consumption of parts-life during peak-firing, the number of FFH per hour of actual peak-fire operation becomes greater than one (e.g., 1 hour of peak-fire operation=2.2 FFH). This simplified FFH model is only intended to be exemplary; in some cases the actual functional relationship between gas turbine operation and FHH consumed may be based on a detailed assessment of physics, risk analysis, or other factors.

According to this FFH approach, a gas turbine that only operates up to its base load will consume its 32,000 FFH parts-life (or maintenance interval) in 32,000 actual hours of operation, whereas a gas turbine that operates in peak-fire mode for at least some of its maintenance interval will consume its parts-life in fewer than 32,000 hours of actual operation, resulting in a shortened maintenance interval.

Some model-based controls allow plant operators to compensate for incremental parts-life consumption resulting from peak-firing periods by cold part-loading (CPL) the gas turbines during other periods. Running gas turbines in CPL mode is less fuel efficient than default operation, but can beneficially extend asset parts-life (in terms of factored fired hours or another parts-life metric), thereby at least partially compensating for the extra parts-life consumed during peak-firing periods. Thus, there is a tradeoff between fuel efficiency and parts-life.

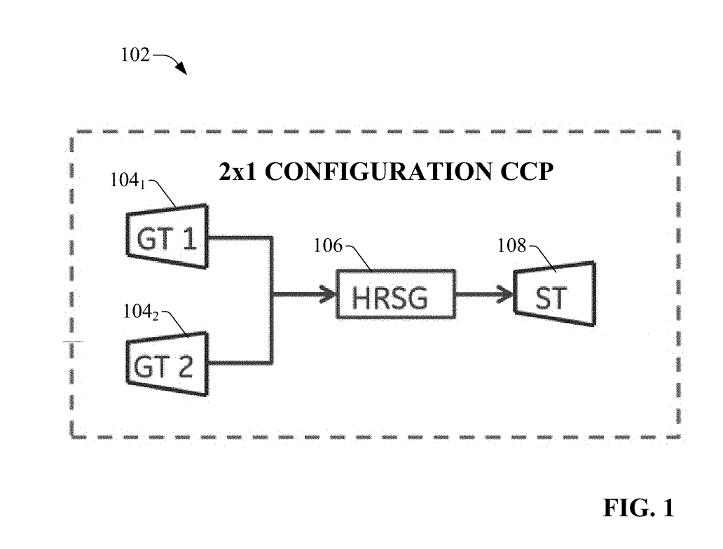

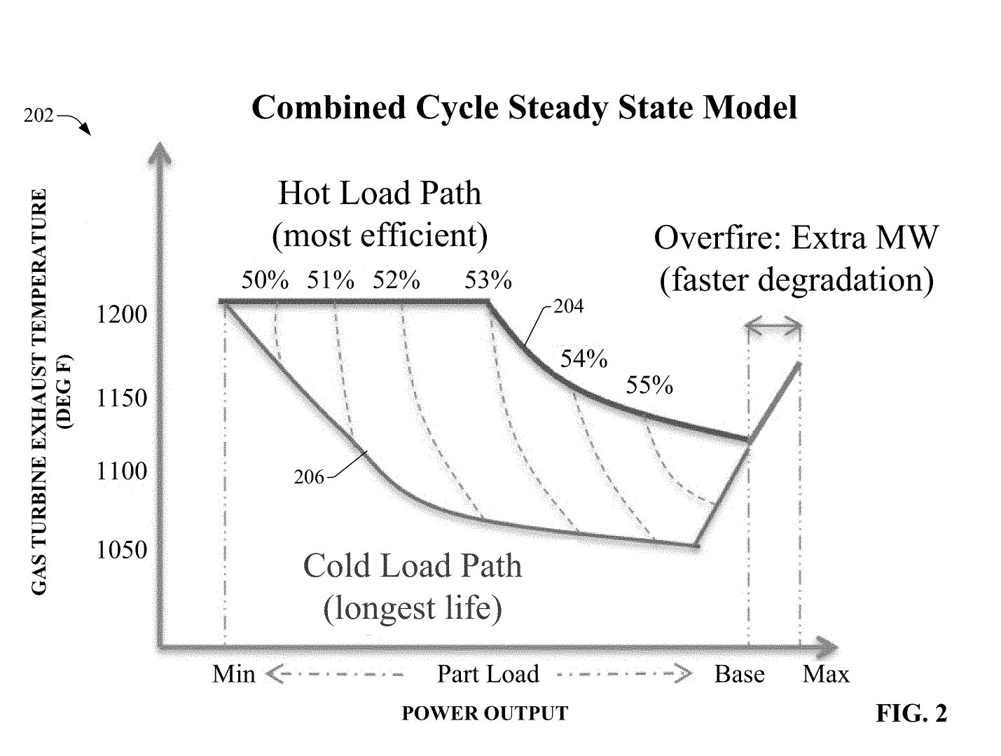

FIG. 1 is a block diagram of an example 2×1 combined cycle plant 102, comprising two gas turbines 104₁ and 104₂, a heat recovery steam generator 106, and a steam turbine 108. FIG. 2 is an example graph 202 of a steady state efficiency model for the combined cycle plant 102. Graph 202 plots the gas turbine operating temperature (represented by the exhaust temperature in this example) as a function of the plant's power output for both hot load operation (line 204) and cold part-load operation (line 206). Between the minimum plant power output and base capacity (non-peak-fire operation), hot load operation—whereby the gas turbines generate power at a higher temperature, as represented by line 204—results in highest fuel efficiency in combined-cycle operations, and is therefore the preferred operating mode for base operation in this scenario. If power output stays below the plant's base capacity of the plant 102 and the gas turbines are operated in hot load mode, the FFH that define the maintenance interval (or life cycle) for the gas turbines are equal to the actual operating hours.

During peak-firing (or over-firing), whereby the plant 102 generates power above the base capacity (up to the plant's maximum capacity), additional megawatts are generated, but at the cost of faster part degradation (parts-life consumption). Some systems adjust the maintenance interval for the plant assets to account for this accelerated parts-life consumption by adjusting the actual number of accumulated operating hours for the assets to yield the FFH metric, which is used to determine when maintenance should next be performed on the assets (e.g., when the factored fired hours reaches 32,000 hours). Since peak-firing consumes parts-life at an accelerated rate, FFH are consumed faster during peak-firing relative to hot load operation below the base capacity. If these consumed FFH are not compensated for within the maintenance interval, the total maintenance interval (or operating horizon) will be shortened, necessitating more frequent maintenance and uncertainty in planned outage dates.

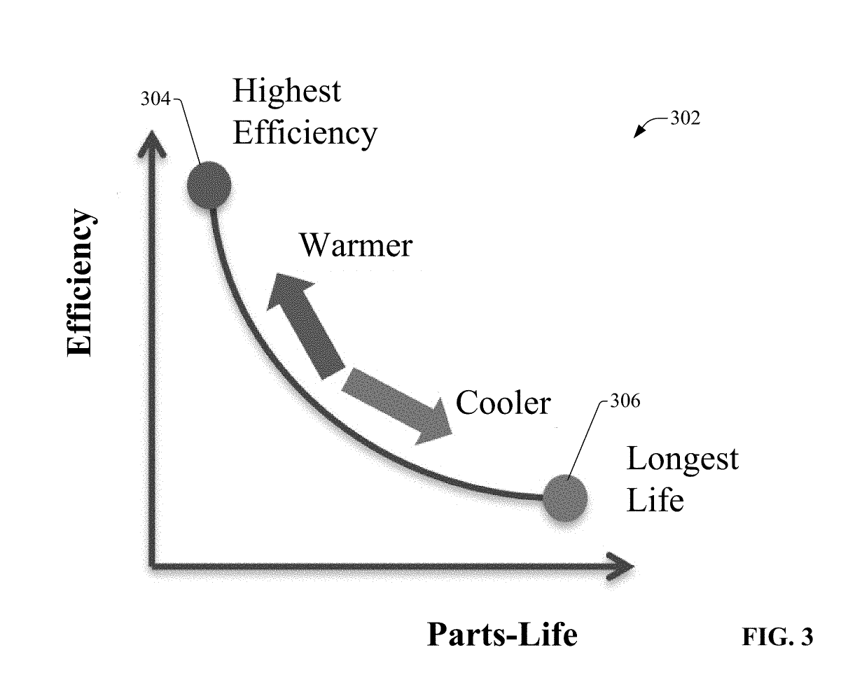

To compensate for FFH consumed during peak firing periods, the plant 102 can be operated in cold part-load (CPL) mode (represented by line 206) during selected non-peak periods. During CPL operation, the gas turbines are operated at lower temperatures relative to hot loading. While CPL operation is less fuel efficient than hot loading, running gas turbines in CPL mode can slow part degradation and extend the maintenance life of the turbines. FIG. 3 is a generalized graph 302 illustrating this tradeoff between asset life and fuel efficiency. Point 304 of graph 302 represents hot load operation (non-peak) and point 306 represents CPL operation. As demonstrated by this graph, higher operating temperatures yield more efficient operation with a shorter parts-life (and a correspondingly shorter maintenance interval), while cooler operating temperatures can extend parts-life at the expense of fuel efficiency.

Thus, whereas peak-firing “consumes” factored fired hours at a faster rate relative to normal hot load operation, CPL operation can “make” factored fired hours, thereby compensating for the extra FFH consumed during peak firing (though at the expense of fuel efficiency). In general, CPL operation creates FFH credits, while peak firing consumes or exhausts these FFH credits (although examples described herein assume that the maintenance interval is defined in terms of FFH, it is to be understood that the maintenance interval may be defined in terms of a different parts-life metric in some systems).

Different costs can be attributed to these operational tradeoffs. The lower fuel efficiency associated with running the gas turbines excessively in CPL mode can increase fuel costs, whereas excessive peak-firing can increase maintenance costs (e.g., customer service maintenance costs) by shortening the maintenance intervals and necessitating more frequent servicing of plant assets. Ideally, profits associated with power production could be substantially maximized if an optimal balance between under-firing and over-firing of the gas turbines across the maintenance interval can be identified. However, finding this substantially optimized balance is rendered difficult due in part to the large number of variable factors to be considered, including hourly fuel costs, electricity costs, and expected electrical demand or load, all of which vary as a function of time across the maintenance interval. The detrimental effects of uncertainty and reduction in operating hours (e.g., uncertainty associated with maintenance planning) can discourage owners from peak-firing their assets. As a result, power-generating plant assets are utilized below their value potential, resulting in loss of potential profit associated with missed opportunities for peak-firing.

To address these and other issues, one or more embodiments of the present disclosure provide systems and methods that substantially maximize the untapped value generated by CPL-compensated peak-firing by optimally balancing the most favorable peak-fire opportunities with the most favorable CPL opportunities. In one or more embodiments, a dispatch optimization system can leverage forecast information and asset performance model data to determine how much parts-life credit (e.g., FFH credit) to accrue, the best times or conditions to accrue the parts-life credit, and the best times or conditions to consume the accrued parts-life credit by peak-firing and producing revenue. In some embodiments, the dispatch optimization system generates an operating profile for one or more gas turbines (or other power-generating assets) that balances the creation and consumption of parts-life credits across the scheduled maintenance interval so that the maintenance interval will not be shortened and additional maintenance costs (e.g., extra customer service agreement charges) will not be accrued. The dispatch optimization system also determines optimal times for creating parts-life credits (by cold part-loading) and consuming the parts-life credits (by peak-firing) that substantially maximize profit given projected energy prices, fuel costs, and demand. In some embodiments, the operating profile can be rendered as a report that can be used as a guideline for operating the gas turbines over the maintenance interval. Alternatively, the dispatch optimization system can output the operating profile to a gas turbine control system, which can automatically regulate operation of the gas turbines in accordance with the profile.

As illustrated in FIG. 2, the physics of combined cycle operations of gas turbines (or certain other power-producing plant assets) offer a certain operating flexibility. In particular, the same combined cycle megawatt output can be generated by either running the gas turbine hotter (which is more fuel efficient and has a nominal impact on life) or running the gas turbine cooler (which is less fuel efficient but has a lower impact on life). This flexibility is available below the base load (also called part-load). In general, the dispatch optimization system described herein assists owners of power-generating plant assets (e.g., gas turbines or other power producing assets) to exploit this flexibility of asset operation in order to offset, manage, and control impact on the operation horizon (or maintenance interval) while allowing for peak-firing, thereby unlocking latent asset value. By varying the extent of cold part-load (CPL) operation, varying levels of parts-life credits can be accumulated. These accumulated parts-life credits can then be used to offset the increased parts-life consumed during peak-firing periods. The dispatch optimization system described herein determines most favorable conditions for CPL operation, as well as degrees of CPL operation, in order to maximize asset utilization while keeping the operating horizon at a specified duration.

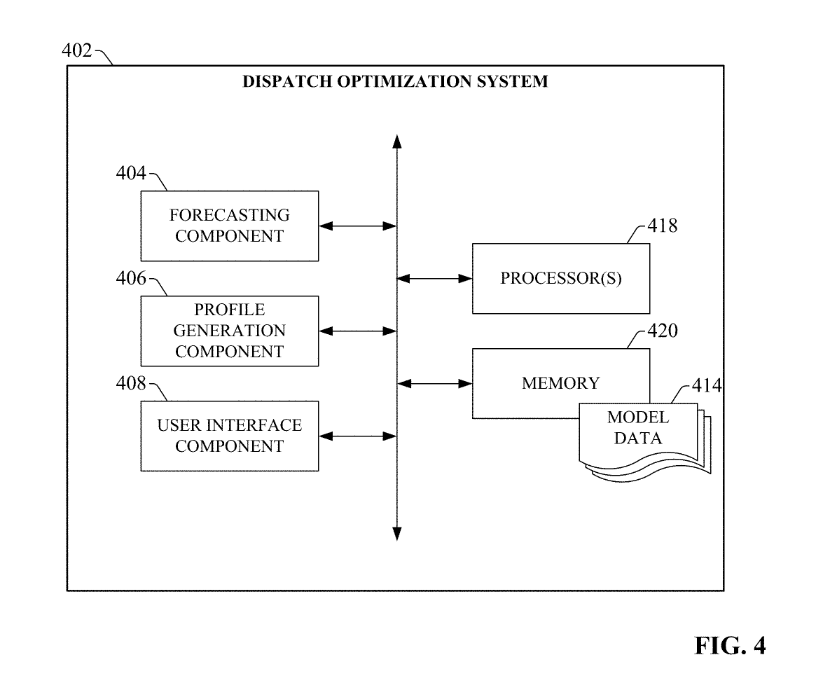

FIG. 4 is a block diagram of an example dispatch optimization system for gas turbines (or other plant assets) according to one or more embodiments of this disclosure. Aspects of the systems, apparatuses, or processes explained in this disclosure can constitute machine-executable components embodied within machine(s), e.g., embodied in one or more computer-readable mediums (or media) associated with one or more machines. Such components, when executed by one or more machines, e.g., computer(s), computing device(s), automation device(s), virtual machine(s), etc., can cause the machine(s) to perform the operations described.

Dispatch optimization system 402 can include a forecasting component 404, a profile generation component 406, a user interface component 408, one or more processors 418, and memory 420. In various embodiments, one or more of the forecasting component 404, profile generation component 406, user interface component 408, the one or more processors 418, and memory 420 can be electrically and/or communicatively coupled to one another to perform one or more of the functions of the dispatch optimization system 402. In some embodiments, one or more of components 404, 406, and 408, can comprise software instructions stored on memory 420 and executed by processor(s) 418. Dispatch optimization system 402 may also interact with other hardware and/or software components not depicted in FIG. 4. For example, processor(s) 418 may interact with one or more external user interface devices, such as a keyboard, a mouse, a display monitor, a touchscreen, or other such interface devices.

Forecasting component 404 can be configured to receive and/or generate forecast data to be used as one or more parameters for generating a substantially optimized operating profile or schedule for a power-generating plant asset (e.g., one or more gas turbines or other such assets). The forecast data can represent predicted conditions across the duration of a maintenance interval for which the operating profile is being generated. These predicted conditions can include, but are not limited to, electrical demand or load, ambient conditions (e.g., temperature, pressure, humidity, etc.), electricity prices, and/or gas prices. In some embodiments, the forecast data can be formatted as hourly data. However, other time units for the hourly data are also within the scope of one or more embodiments. In general, the time base for the forecast data will match the time base for the operating profile. Moreover, in addition to or as an alternative to time-series data, some embodiments can be configured to consider market conditions and ambient conditions in statistical representations—such as histograms or probability distributions—rather than as time-series data.

Profile generation component 406 can be configured to determine a suitable plant asset operating profile for the maintenance interval, given the forecast data, that substantially maximizes profits and maintains the specified parts-life target life for the plant assets. The profile generation component 406 generates the operating profile based on the forecast data, performance models for the one or more plant assets being assessed, and a calculated “price of life” value representing a monetary value of parts-life credited or consumed. In the case of systems that measure parts-life in terms of factored fired hours, the price of life will have a unit of $/FFH. As will be discussed in more detail below, this price of life estimate can reduce the computational burden associated with determining the optimized operating profile. In some embodiments, the operating profile can be generated as an hourly operating schedule defining one or both of a power output and an operating temperature for the power-generating plant assets for each hour of the maintenance interval (although the examples described herein assume an hourly time base, other time bases for the operating profile are also within the scope of one or more embodiments). The profile generation component 406 can also output the price of life estimate determined for the maintenance interval.

The user interface component 408 can be configured to receive user input and to render output to the user in any suitable format (e.g., visual, audio, tactile, etc.). In some embodiments, user interface component 408 can be configured to generate a graphical user interface that can be rendered on a client device that communicatively interfaces with the dispatch optimization system 402, or on a native display component of the system 402 (e.g., a display monitor or screen). Input data can include, for example, user-defined constraints to be taken into account when generating an operating profile (e.g., upper and lower limits on gas turbine operating temperature or power output, definition of a desired operating horizon, identification of days during which the gas turbines are not allowed to run, etc.). Output data can include, for example, a text-based or graphical rendering of a plant asset operating profile or schedule.

The one or more processors 418 can perform one or more of the functions described herein with reference to the systems and/or methods disclosed. Memory 420 can be a computer-readable storage medium storing computer-executable instructions and/or information for performing the functions described herein with reference to the systems and/or methods disclosed.

Although features of the dispatch optimization system 402 are described herein with reference to gas turbines, it is to be appreciated that embodiments of the dispatch optimization system 402 are not limited to use with gas turbines, but rather can generate operating profiles or schedules for other types of power-generating assets.

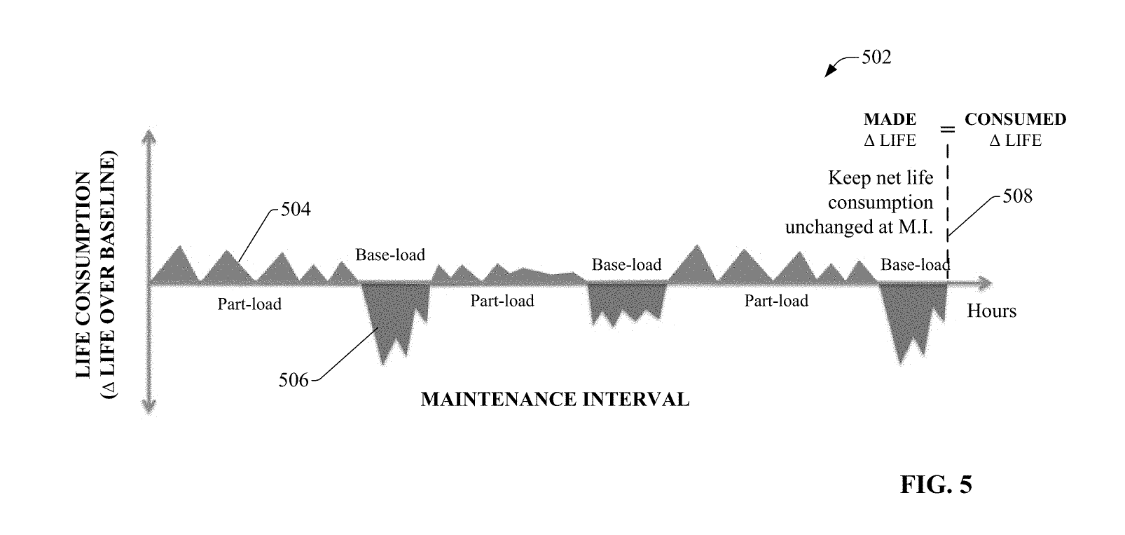

FIG. 5 is a graph 502 plotting the change in parts-life for a gas turbine or a set of gas turbines as a function of time over a total maintenance interval for an example operating scenario. The vertical dashed line 508 represents the target life for the plant asset, or the time at which the next maintenance service will be scheduled if no peak-firing or CPL operation is performed during the maintenance interval. This target life may be defined in terms of a number of factored fired hours (e.g., 32,000 factored hours), or another parts-life metric. If the gas turbines are only operated to output power up to the base capacity in hot load mode throughout the maintenance interval (referred to as baseline operation), the target life will be reached when the number of actual operating hours (or fired hours) reaches the scheduled number of factored fired hours defining the target life.

As noted above, when the plant assets are peak-fired, the number of remaining factored fired hours is adjusted downward relative to baseline operation to reflect faster parts-life consumption. The negative curves 506 of graph 502 represent peak-fire periods, which cause a downward adjustment to the maintenance interval duration relative to the baseline (i.e., a negative change of life). When the gas turbines are cold part-loaded, the number of remaining FFH is adjusted upward to reflect slower parts-life consumption relative to baseline operation. The positive curves 504 of graph 502 represent CPL operation, which causes an upward adjustment to the maintenance interval duration relative to the baseline (i.e., a positive change of life).

As demonstrated by graph 502, CPL operation creates FFH credits (or, more generally, parts-life credits), while peak-firing consumes or exhausts these FFH credits. If the “consumed” FFH credits are balanced with the “made” FFH credits across the maintenance interval (“made” A life=“consumed” A life), the net parts-life for the maintenance interval remains unchanged and the maintenance interval will not be shortened (that is, target life 508 will not be pulled in). Depending on such factors as the energy demand, fuel prices, and energy prices at each time unit (e.g., hour) of the maintenance interval, the overall profit from operating the plant assets over the maintenance interval is partly a function of the selected times during which the assets are peak-fired and cold part-loaded.

The dispatch optimization system 402 described herein is configured to determine a suitable operating schedule for the plant assets (e.g., gas turbines) that substantially maximizes the profit over the maintenance interval by identifying the most favorable peak-firing opportunities given load and ambient condition forecasts as well as performance model data for the plant assets, and balancing these peak-firing times by identifying most favorable opportunities for CPL operation such that the target life for the assets remains substantially unchanged.

In order to solve this optimization problem with minimal computational burden despite the long operating horizon, the dispatch optimization system 402 generates this operating profile based on an estimated price of life value k, which represents an incremental extra amount of profit for incremental additional life. In this regard, the dispatch optimization system 402 accounts for creation (by CPL) and exhaustion (by peak fire operation) of FFH credits by means of computing the cost of such FFH credits based on an estimated price of life value λ (in units of $/FFH). In an example scenario, it may be determined that, based on the cost of fuel for a given hour, one unit of parts-life saved by CPL operation costs $1 in additional fuel due to the reduced fuel efficiency of CPL operation. It may also be determined that one unit of parts-life lost as a result of peak-firing will produce one extra MW of power. It can therefore be assumed that it is worth saving life via CPL operation only if the electricity price is greater than $1/MWh.

In some embodiments, the price of life λ may be a vector quantity for a given plant asset. For example, a given plant asset may comprise multiple stages, where each stage has a different target life (or maintenance interval). In such scenarios, each stage may have a different price of life value, where the set of price of life values for all stages of the asset make up a price of life vector.

If an estimated ideal price of life is known, the problem simplifies to deciding, at each time unit of the maintenance interval (or in the case of statistical data, each operating condition), the value of the plant output (typically in MW) and/or operating temperature (e.g., exhaust temperature, inlet temperature, etc.) that maximizes profit, as given generally by:

Profit=(Electricity revenue)−(Cost of Fuel Burn)−(Cost of Life) (1)

The electricity revenue can be determined based on the product of the electricity price for the time unit and the power output (e.g., MWh) generated for the time unit. The cost of fuel burn can be determined based on the product of the fuel cost for the time unit and the amount of fuel consumed during the time unit (which can be determined based on performance model data for the plant asset that models the asset's fuel consumption as a function of one or both of power output and/or operating temperature). The cost of life can be determined based on the product of the estimated price of life λ and the number of FFH consumed (which can be determined based on parts-life model data for the plant asset that models the consumed FFH as a function of one or both of power output and/or operating temperature).

As will be described in more detail below, the dispatch optimization system 402 uses an iterative analysis technique to determine, for each time unit (e.g., hour) of the maintenance interval, a recommended output (MW) and/or operating temperature (T) for the plant asset that a maximum profit for the maintenance interval while satisfying the target life constraint (that is, without significantly altering the duration of the maintenance interval). This iterative technique comprises an inner loop iteration and an outer loop iteration. The inner loop determines an operating profile that maximizes the profit for each time unit of the maintenance interval according to equation (1) given an estimated price of life value λ. The outer loop then determines whether the target parts-life resulting from the operating profile is substantially equal to the actual target parts-life for the plant asset (within a defined tolerance). If this target parts-life constraint is not satisfied, the estimated price of life value λ is adjusted in the appropriate direction, and the inner loop is re-executed using the adjusted price of life value. These iterations are repeated until a profit maximizing operating profile is found that satisfies the target parts-life constraint for the asset (that is, an operating profile that results in a maintenance interval that is substantially equal to the target maintenance interval with a defined tolerance).

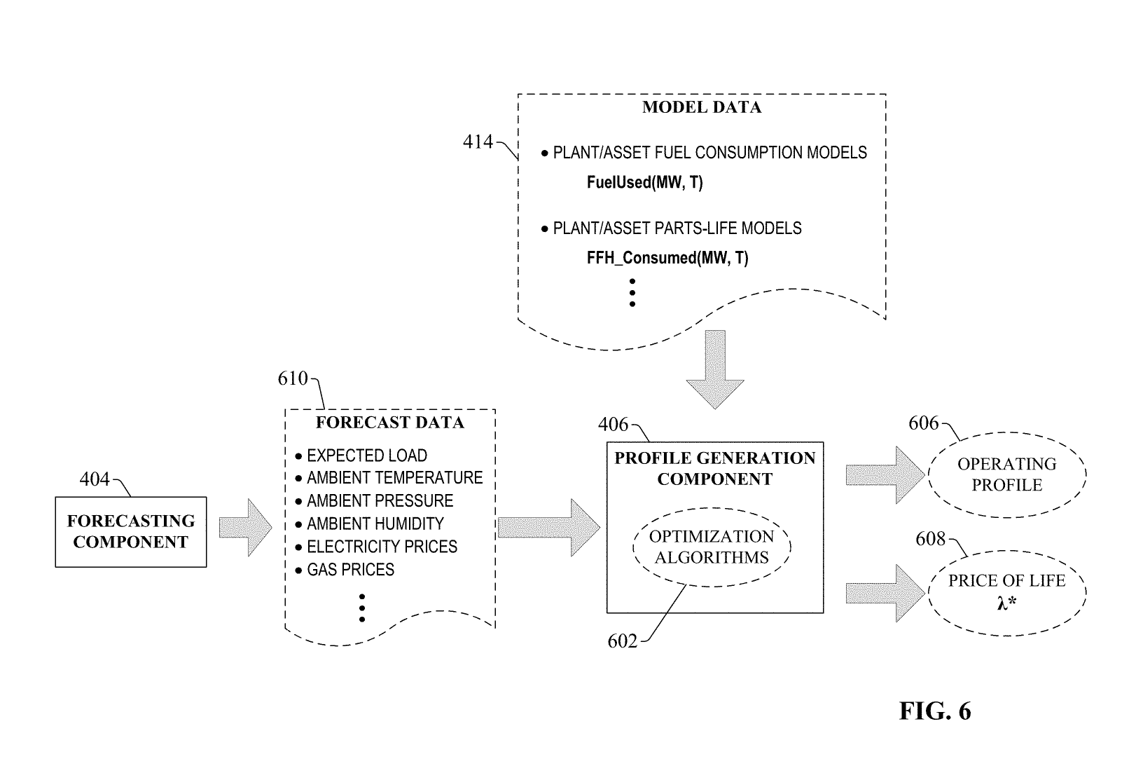

FIG. 6 is a block diagram illustrating example data inputs and outputs for the profile generation component 406 of the dispatch optimization system 402. In the examples described herein, the plant assets are assumed to be a set of gas turbines. However, it is to be appreciated that the optimization techniques carried out by embodiments of the dispatch optimization system 402 are also applicable to other types of power-generating plant assets. Moreover, although the examples described herein assume an operating profile having an hourly time base, other time bases are also within the scope of one or more embodiments. Also, while the parts-life metric in the following examples is assumed to be FFH, some embodiments of the dispatch optimization system 402 can be configured to determine operating profiles based on other parts-life metrics.

Profile generation component 406 is configured to execute one or more optimization algorithms 602 that perform the inner loop and outer loop iterations described above. In order to accurately calculate the cost of fuel burn and the cost of consumed FFH (or another parts-life metric) by the gas turbines, the dispatch optimization system 402 is provided with model data 414, including one or more fuel consumption models and one or more parts-life models for the gas turbines. These models can be customized to the particular gas turbines under investigation based on engineering specifications, historical operation data, or other such information.

An example fuel consumption model may define an estimated amount of fuel consumed by the gas turbines for a given time unit (e.g., an hour) as a function of the power output MW and the operating temperature T (which may be an exhaust temperature, an inlet temperature, or another temperature indicative of the overall operating temperature), and/or ambient conditions Amb such as ambient temperature, pressure, humidity, etc. Such performance models may be stored on memory 420 associated with the dispatch optimization system 402, either as a mathematical function (e.g., FuelUsed(MW, T, Amb)) describing the relationship between fuel consumption and combinations of MW and T for a given Amb, or as a table of precomputed values that can be accessed by the profile generation component 406 as needed in order to obtain fuel consumption estimations for different operating scenarios.

An example parts-life model may define an estimated number of factored fired hours (or other parts-life metric) consumed for a given time unit as a function of power output MW and operating temperature T, and/or ambient conditions Amb such as ambient temperature, pressure, humidity, etc. Similar to the fuel consumption model, the parts-life model can be stored on memory 420, either as a mathematical function (e.g., FHH_Consumed(MW, T, Amb)) describing the relationship between FFH consumed and combinations of MW and T for a given Amb, or as a table of precomputed values that can be accessed by the profile generation component 406 as needed in order to obtain FHH consumption estimations for different operating scenarios.

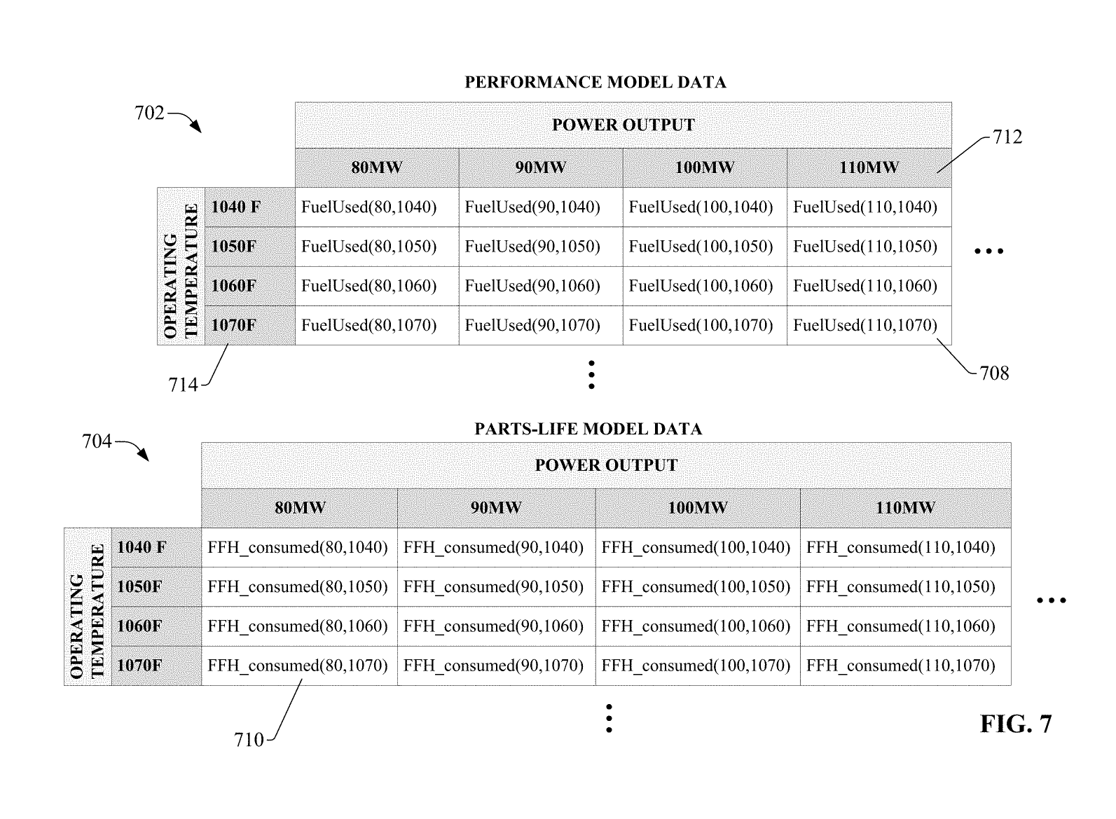

FIG. 7 illustrates example tabular formats for pre-stored model data values for a given Amb. Table 702 is an example data table corresponding to a performance model (e.g., FuelUsed(MW, T)), and table 704 is an example data table corresponding to a parts-life model (e.g., FFH_consumed(MW, T)). Performance model data table 702 is a two-dimensional grid of fuel consumption values 708 for respective combinations of power output MW (columns 712) and operating temperature T (rows 714). For embodiments in which the model data is stored as pre-computed values, the performance model data values can be stored in memory 420 in a format similar to that shown in table 702 (or another suitable format), whereby precomputed data values 708 representing the amount of fuel consumed for a given combination of power output (MW) and operating temperature (T) are stored for a range of [MW, T] pairs (e.g., as comma-delimited data or any other suitable storage format). During an iteration of the optimization process to be described in more detail below, the profile generation component 406 can access table 702 and retrieve the pre-stored value of FuelUsed(MW, T) corresponding to the power output and operating temperature value pair that most closely match the pair of test values under consideration for the current iteration of a given hour. Pre-storing these precomputed values can reduce the computational burden of the optimization process relative to storing the model data as mathematical functions that must be executed with each iteration in order to compute the amount of fuel consumed for a given [MW, T] pair.

The parts-life model data table 704 can be stored in a similar format. In particular, the parts-life model data table comprises a grid of values 710 representing the number of FFH consumed during a time unit (e.g., an hour) in which the one or more gas turbines output an amount of power MW at an operating temperature of T for a range of values of MW and T. During operation, the profile generation component 406 can access table 704 to retrieve the number of FFH consumed for a given [MW, T] pair being considered in a current iteration of the optimization sequence.

The data values 708 and 710 can be stored at any suitable degree of granularity of MW and T values. The degree of granularity may depend, for example, on the constraints of the computational environment on which the dispatch optimization system runs, whereby environments with sufficiently large data storage capacity can store the data values 708 and 710 at a higher degree of granularity (resulting in a larger number of pre-computed values). In the example tables 702 and 704 depicted in FIG. 7, the data values 708 and 710 are stored at a granularity of 10 MW and 10° F. However, other suitable granularities are also within the scope of one or more embodiments. If the values of MW and T being considered by the profile generation component 406 fall between the available values of MW and/or T represented in tables 702 and 704, the profile generation component 406 may select values of MW and T represented in tables 702 and 704 that are nearest to the values of MW and T being considered (e.g., by rounding the values under consideration to the nearest tabulated values), and select the fuel consumption and FFH values corresponding to these nearest values of MW and T. Alternatively, in some embodiments, the profile generation component 406 may be configured to interpolate between the tabulated values 708 and 710 if the actual values of MW and T being considered fall between tabulated values represented in tables 702 and 704.

While FIG. 7 depicts the fuel consumption values and FFH values as being functions solely of power output and operating temperature, some embodiments may model the fuel consumption and FFH consumption as functions of additional factors. In such embodiments, the pre-calculated data values may be stored as higher order tables depending on the number of variables used to calculated fuel consumption and FFH. Also, while deterministic models are assumed in the present example, in some embodiments stochastic models may be used to model the performance and parts-life for a given plant asset.

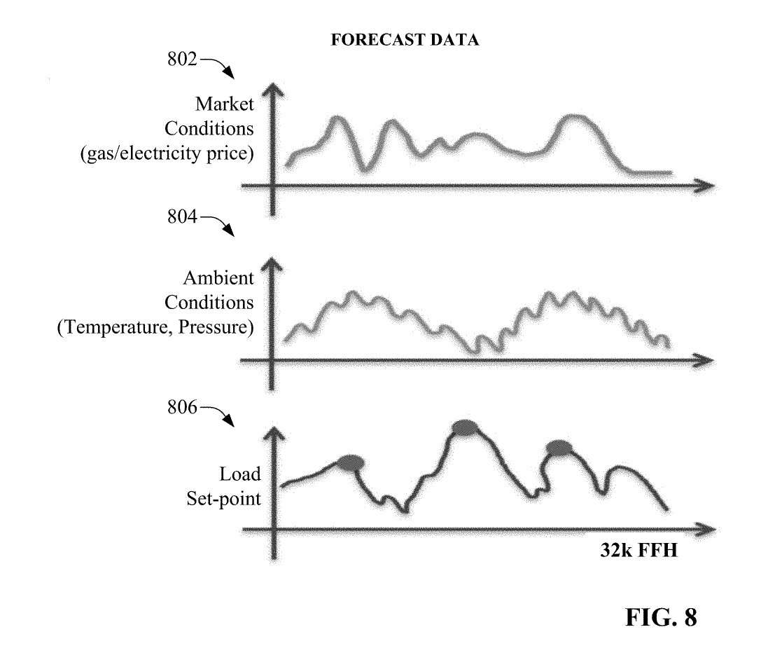

Returning now to FIG. 6, forecast data 610 provided to the system is now described. When an operating profile for one or more gas turbines (or other plant assets) is to be generated for an operating interval (e.g., a maintenance interval), forecast data 610 is leveraged to provide a nominal prediction of operations and conditions for the operating interval being planned. Forecast data 610 can comprise time-based information (e.g., hourly data) describing expected ambient conditions and/or market factors that play a role in deciding when to peak-fire the gas turbines and when to operate the gas turbines in CPL mode, where the forecast data 610 encompasses a time range corresponding to the operating interval being planned. FIG. 8 depicts graphs that plot example forecast data under three categories—predicted market conditions (graph 802), predicted ambient conditions (graph 804), and predicted load or electrical demand (graph 806). Predicted market conditions can include for example, predicted hourly electricity prices and predicted hourly gas prices (or hourly prices for other types of fuel burned by the plant assets under investigation). Predicted ambient conditions can include, for example, predicted hourly temperature, pressure, and/or humidity. The time range for the forecast data 610 encompasses the hours that make up the maintenance interval being planned (e.g., a 32,000 FFH duration in the present example). Although the forecast data 610 is described as having an hourly time base, other time bases may be used without departing from the scope of one or more embodiments described herein. In general, the time base for the forecast data 610 will match the time base used for plant operation (e.g., hourly data for power plants that participate in day-ahead electricity markets).

Returning now to FIG. 6, in some embodiments, some or all of the forecast data 610 can be entered into the dispatch optimization system 402 by the user (e.g., via user interface component 408). Alternatively, forecasting component 404 may be configured to retrieve some or all of the forecast data 610 from external sources of forecast information, including but not limited to weather forecasting websites, electricity and/or gas market websites, or other such sources. In yet another example, forecasting component 404 can be configured to generate some or all of the forecast data 610 based on analysis of relevant data sets provided to the forecasting component 404. For example, in some embodiments, forecasting component 404 can be configured to execute load forecasting algorithms that generate an expected hourly electrical demand for the maintenance interval based on forecasted weather or ambient conditions for the maintenance interval. In such embodiments, the forecasting component 404 can be provided with such ambient condition information as an expected hourly temperature, an expected hourly pressure, and/or an expected hourly humidity, and based on this ambient condition information, generate an expected hourly electrical demand. The forecasting component 404 can execute any suitable forecasting algorithms for generating an hourly predicted electrical load based on a given set of hourly ambient data.

The profile generation component 406 combines at least a subset of the forecast data 610 with the model data 414 representing asset performance and parts-life for the gas turbines to form an optimization problem with an objective of maximizing profit subject to maintaining one or more specified parts-life targets and other operability conditions. In the present example, the variables of the problem are plant output MW and operating temperature T, which may be an exhaust temperature, an inlet temperature, or another factor indicative of the overall operating temperature. The plant output variable MW is associated with the ability to peak-fire the gas turbines to capture extra revenue, and the operating temperature T sets the level of CPL operation.

The profile generation component 406 solves the optimization problem to yield an operating profile 606 (also referred to as an operating schedule), which defines recommended hourly operating parameters—in terms of power output MW and operating temperature T in the present example—determined to maximize profit for the maintenance interval without significantly changing the target life for the asset (that is, without significantly changing the duration of the maintenance interval). The operating profile 606 identifies suitable peak-firing opportunities within the maintenance interval as well as suitable periods during which to operate in CPL mode in order to compensate for the additional FFH consumed during the peak-fire periods. In this way, the system 402 generates an operating profile 606 serves as a guide to substantially maximizing utilization of the plant asset without shortening the maintenance interval or otherwise increasing customer service agreement charges.

The profile generation component 406 also generates an estimated price of life value λ*608, which is derived in parallel with the operating profile 606, as will be described in more detail below.

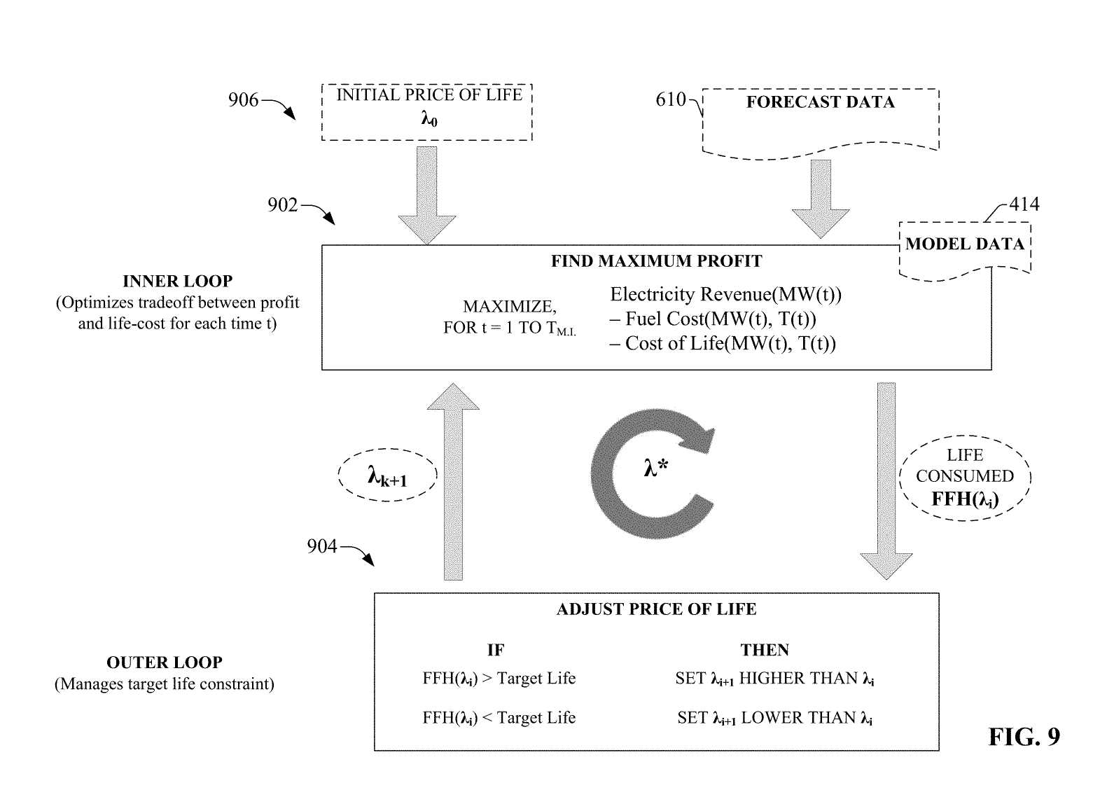

FIG. 9 is a computational block diagram illustrating the iterative analysis performed on the forecast data 610 and the model data 414 by the profile generation component 406 to produce the substantially optimized operating profile 606. In general, the profile generation component 406 uses a two-layer iteration approach to solve the optimization problem, whereby the iteration processing comprises an inner loop 902 and an outer loop 904. The problem solved by iterations of the inner and outer loops can be defined as maximizing the profit generated over the maintenance interval subject to the target parts-life constraint. In mathematical terms, this problem can be stated as:

$$\begin{matrix}Maximize \\ {\sum }_{t = 1}^{{T}_{M . I .}} \{ ( electricity price ) ( M W ) - ( fue l price ) ( T ) \} \\ Subject to \\ {\sum }_{t = 1}^{{T}_{M . I .}} FFH \leq target life\end{matrix}$$

where T_{M.I.} is the duration of the maintenance interval, and the range of operating temperature T is limited by the operating temperature range of the turbines (i.e., Tₘᵢₙ≤T≤Tₘₐₓ). Although the example analysis described herein assumes a parts-life metric defined in terms of FFH, it is to be appreciated that other metrics for parts-life may also be used without departing from the scope of one or more embodiments of this disclosure. Moreover, while the examples described herein assume time-based operating profiles and forecast data, some embodiments of the profile generation component 406 can also perform a statistical-based analysis that generates a condition-based operating profile rather than a time-based profile.

Performing this optimization for multiple iterations over a large maintenance interval (e.g., 32,000 hours) can result in a large optimization problem. In order to reduce the computational burden associated with solving the optimization problem, the profile generation component 406 uses the price of life metric λ to account for creation (by CPL operation) and exhaustion (by peak-fire operation) of FFH credits by computing the cost of the FFH created or consumed, and factoring this cost into the profit calculation.

In general, the inner loop 902 finds an hourly schedule of power output MW and operating temperature T determined to maximize or substantially maximize the profit over the maintenance duration (e.g., by maximizing equation (1)), given an estimated price of life λ. This may include identifying an hourly schedule of MW and T that balances peak-fire durations (which consumed FFH credits) with CPL durations (which creates FFH credits) in a manner determined to maximize profit for the maintenance duration as a whole.

Since the profit for a given hour depends on the electricity prices and the fuel costs for that hour, the profile generation component 406 uses the predicted market information included in forecast data 610—the electricity prices and gas prices—together with the asset performance models represented by model data 414. For example, the profit given by equation (1) above can be rewritten as

Profit=ElecPrice(t)*MW(t)−FuelPrice(t)*FuelUsed(MW(t),T(t))−λ*FFH_consumed(MW(t),T(t)) (2)

where ElecPrice(t) is the forecasted price of electricity as a function of time, and FuelPrice(t) is the forecasted price of fuel (e.g., gas prices in the case of gas turbines) as a function of time, both of which are obtained from the hourly forecast data 610. Note that the profit given by equation (2) takes into account the cost of life (FFH) consumed, as represented by a product of the price of life λ and the number of FFH consumed as a result of generating a power output MW at an operating temperature of T for the time unit (e.g., hour) in question.

As noted above, the values of FuelUsed(MW(t), T(t)) and FFH_consumed*(MW(t), T(t)) can be obtained for each iteration of the inner loop based on the model data 414, which includes performance model data FuelUsed(MW, T) and parts life model data FFH_consumed(MW, T). This model data can be stored as respective mathematical functions or as an array of pre-calculated values (as illustrated in FIG. 7). Storing the model data as pre-calculated values can significantly improve execution time of the iterations by reducing the inner loop optimization to essentially arithmetic operations followed by comparisons, thereby eliminating the need to evaluate mathematical functions over successive outer loop iterations.

After the forecast data 610 has been provided to the dispatch optimization system 402, the user can initiate an operating profile generation sequence for a given maintenance interval (the maintenance interval covered by the time range of the forecast data 610). In some embodiments, the user can enter one or more additional constraints (e.g., via user interface component 408) prior to initiation of the profile generation sequence. These user-defined constraints can include, for example, upper and lower limits on the operating temperature or power output, modifications to the desired operating horizon (that is, modifications to the target duration of the maintenance interval), identification of days during which the gas turbines are not allowed to run (e.g., based on plant shut-down schedules), or other such constraints. In addition, in some scenarios the forecasted load or electrical demand for each hour of the maintenance interval can be used as a constraint on the optimization problem. For example, the user may specify that the power output for a given hour of the maintenance interval is not to exceed the forecasted load for that hour, or is not to exceed the forecasted load plus a tolerance adder. In addition, additional operating variables corresponding to other options available to a customer such as duct-burners, evaporative coolers, chillers, etc. can be added to the dispatch optimization system.

Initially, for the first set of iterations of the inner loop 902, an initial price of life estimate λ₀ 906 is used. Using this initial price of life estimate, the profile generation component 406 determines an initial hourly schedule of MW and T determined to maximize the profit given by equation (2) for each hour of the maintenance interval being planned (although the example described herein assumes an hourly time base, other time units are also within the scope of one or more embodiments). That is, the profile generation component 406 determines, for each time unit t=0 to T_{M.I.} (where T_{M.I.} is the number of time units in the maintenance interval; e.g., 32,000 fired hours), values of the power output MW(t) and operating temperature T(t) that maximize or substantially maximize equation (2) for each hour. During this inner loop processing, the profile generation component 406 can reference the forecast data 610 to determine the predicted electricity price ElecPrice(t) and fuel price FuelPrice(t) for a given time unit (e.g. an hour) t. The profile generation component can also reference model data 414 to determine the expected amount of fuel consumed FuelUsed(MW(t), T(t)) and the expected amount of FFH consumed FFH_consumed(MW(t), T(t)) for a given combination of power output MW and operating temperature T. The profile generation component 406 may perform multiple iterations of the inner loop for each hour in order to converge on values of MW and T that maximum profit for that hour, given the expected electricity prices, expected fuel prices (e.g., gas prices), and estimated price of life (as well as any defined upper and lower limits on MW and T).

The hourly schedule of MW and T generated as a result of the first execution of the inner loop 902 represents a provisional operating schedule, subject to verification that the operating schedule satisfies the target life constraint. After the inner loop processing has determined this provisional hourly operating schedule of MW and T determined to maximize profit for the maintenance interval (the first execution of inner loop 902), the profile generation component 406 executes the outer loop 904 to determine whether the provisional operating schedule satisfies the target life constraint. As noted above, the target life constraint can be described as

$${\sum }_{t = 1}^{{T}_{M . I .}} FFH \leq target life$$

In general, the profile generation component 406 seeks to determine a profit-maximizing hourly operating profile for the maintenance interval that also keeps the total number of consumed FFH at or below the target life of the maintenance interval (e.g., 32,000 fired hours). That is, the amount of extra FFH life consumed during peak-fire hours defined by the operating profile should be substantially equal (within a defined tolerance) to an amount of extra FFH life credited during CPL hours defined by the operating profile. This ensures that the maintenance interval will not be shortened and associated additional maintenance costs will not be incurred, while at the same time optimizing utilization of the plant asset's capacity over the maintenance interval given forecasted conditions.

To this end, once a provisional operating profile has been generated by the inner loop processing, the profile generation component 406 executes the outer loop 904 of the iterative processing, which determines the total number of FFH that will be consumed as a result of operating the assets in accordance with the provisional operating profile and determines whether the number of consumed FFH satisfies the target life constraint. In general, the sum of the FFH consumed over the maintenance interval should be equal to or less than the target life (e.g., 32,000 FFH). In some embodiments, the profile generation component 406 can determine the amount of parts-life consumed over the maintenance interval based on the parts-life model data and the scheduled values of MW and T for the operating profile, such that the constraint can be given by

$${\sum }_{t = 1}^{{T}_{M . I .}} FFH\_consumed ( M W ( t ) , T ( t ) ) \leq target life$$

The outer loop 904 of the iterative processing performed by the profile generation component 406 compares the target life for the gas turbines with the total amount of FFH that would be consumed over the duration of the maintenance interval if the gas turbines were operated in accordance with the provisional operating profile. If the total consumed FFH is found to be greater than the target life (outside a defined tolerance window), it is assumed that the price of life λ₀ was underestimated during the first execution of the inner loop, and the profile generation component 406 increases the estimated price of life λ₁ for the next execution of the inner loop. Alternatively, if the total consumed FFH is found to be less than the target life (outside of a defined tolerance window), it is assumed that the estimated price of life λ₀ was overestimated during the first execution of the inner loop, and the profile generation component 406 decreases the estimated price of life λ₁ for the next execution of the inner loop. The profile generation component 406 then re-executes inner loop processing using the updated price of life value λ₁, and a new provisional operating profile is generated, wherein the new provisional operating profile comprises an updated hourly schedule of power output MW and operating temperature T calculated based on equation (2) using the same forecast data 610 and the updated price of life value λ₁. The profile generation component 406 performs multiple iterations of the inner and outer loop processing in this manner—calculating new provisional operating profiles and adjusting the price of life value λ₁ (where i is the iteration index) if the calculated amount of consumed FFH does not satisfy the target life constraint—until an optimal price of life λ* is found that causes the inner loop to generate an operating profile that satisfies the target life constraint.

In general, the profile generation component 406 iterates over multiple values of the price of life λᵢ in the outer loop, solving the inner loop for each for each value of λᵢ, and terminating the outer loop based on the responses received from the inner loop to past price of life values. In some embodiments, the manner in which the outer loop selects the next price of life value λᵢ may depend on the past values of λᵢ and the corresponding inner loop responses. If the inner loop response to the current value of λᵢ results in violation of the target life constraint, the outer loop can decide to increase λᵢ₊₁ for the next iteration, and continue to do so until the inner loop response produces an operating profile that satisfies the life target. In the other direction, if the inner loop response given a price of life value λᵢ does not violate the life target (e.g., the provisional operating profile consumes an estimated amount of FFH less than the target life), the outer loop can increase λᵢ₊₁ for the next iteration to bring the estimated total consumed FFH closer to the target life. The inner and outer loop iterations can then be terminated when the consumed FFH for the current provisional operating profile is approximately equal to the target life (within a defined tolerance).

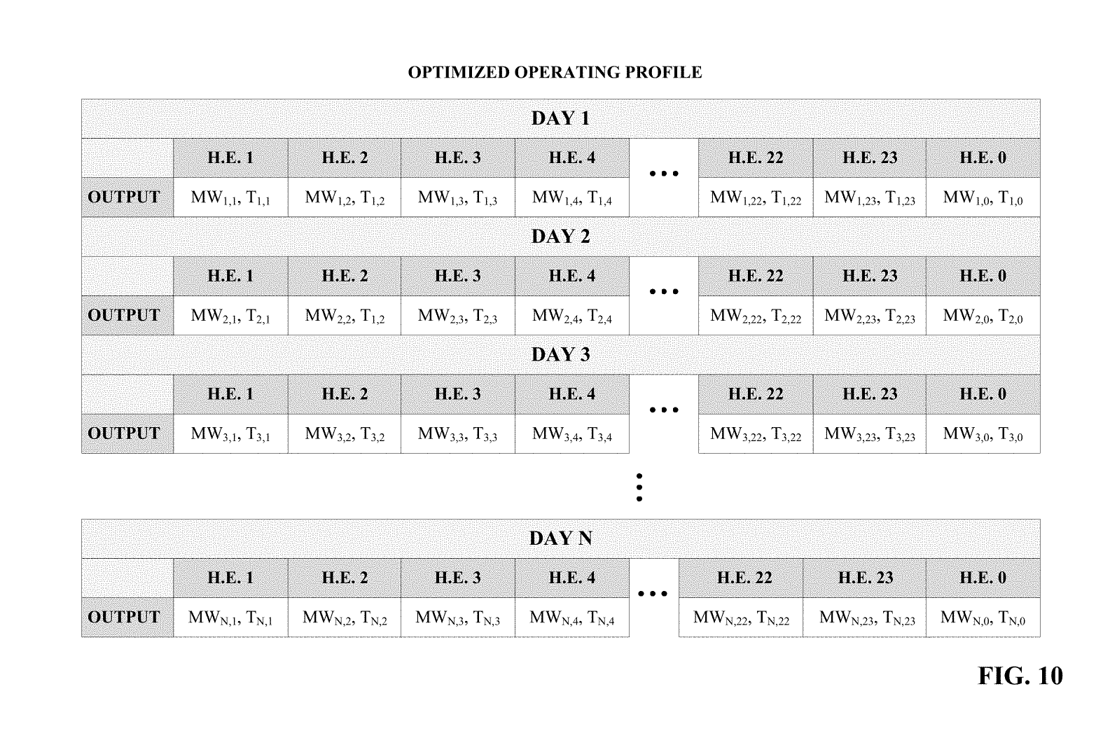

When the iterations are terminated as a result of the target life being satisfied, the user interface component 408 can output the operating profile 606 generated by the last iteration of the inner loop as the recommended operating profile for the gas turbines. The system 402 also outputs the presumed optimal price of life value λ* that gave rise to this operating profile. In some embodiments, the resulting operating profile can be rendered as a recommended hourly schedule of gas turbine power output and operating temperature for each day of the maintenance interval. FIG. 10 is an example display format for an operating profile. As shown in this example, each day is divided into hours (Hour Ending 1, Hour Ending 2, etc.), with each hour specifying a recommended plant output and operating temperature (exhaust temperature in this example) defined by the operating profile 606.

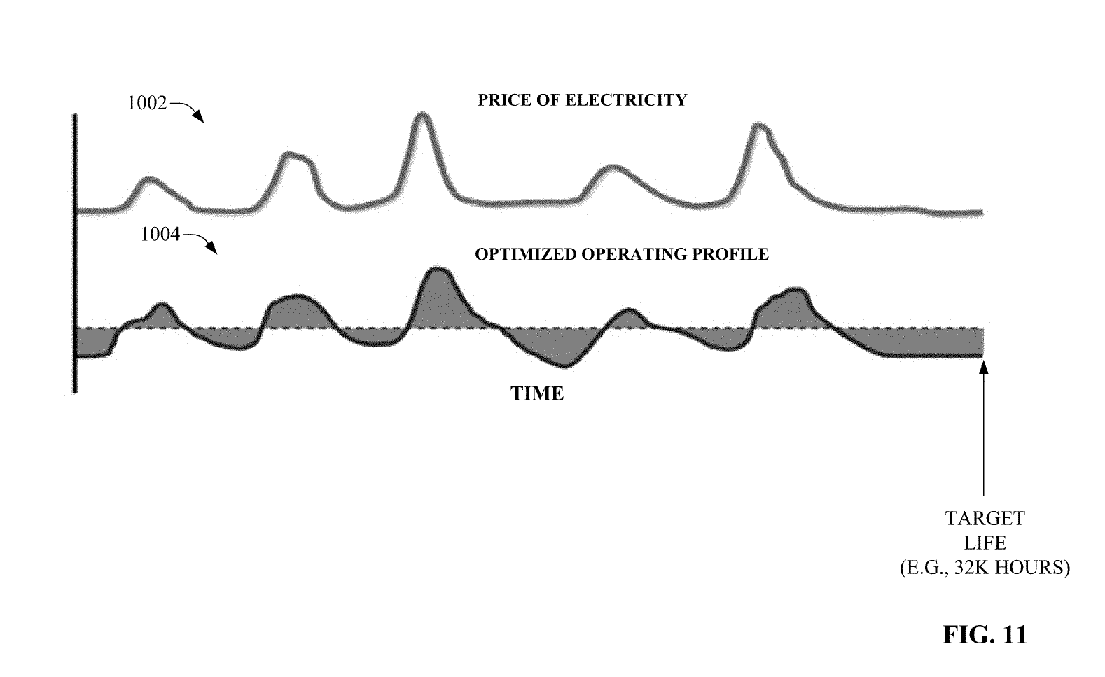

In some embodiments, the user interface component 408 can output a graphical representation of the optimized operating profile 606, as well as any other factors on which the profile was based. FIG. 11 is an example graphic that plots the recommended operating temperature defined by the operating profile over the duration of the maintenance interval (graph 1004) together with the predicted hourly electricity prices over the same maintenance interval. User interface component 408 can allow the user to add or remove variables from the graphical display (e.g., fuel prices, expected electrical demand) for comparison with the recommended operating profile.

Also, in some embodiments, the dispatch optimization system 402 can export the operating profile to a plant asset control or scheduling system, so that that the operating schedule represented by the profile is automatically programmed into the asset's control system.

Although the example described above assumed a single price of life value λ for the asset under investigation, some embodiments of the dispatch optimization system 402 can support analysis based on a price of life vector quantity comprising separate price of life values for respective different stages or components of a plant asset. For example, some plant assets may comprise multiple different stages (e.g., turbine, combustor, heat recovery steam generator, steam turbine components, etc.), each having a different target life. In such scenarios, the profile generation component 406 can calculate the profit-maximizing operating profile for the plant asset using a price of life vector quantity that includes price of life components corresponding to the respective stages. In such scenarios, the profile generation component 406 can execute the outer loop of the iterative analysis over a vector-valued price of life, with each component of the vector corresponding to corresponding life target for a given stage.

In the examples described above, the target life used as a constraint for the iterative analysis is assumed to be a constant value. However, in some embodiments the profile generation component 406 can be configured to solve the maximization problem using the target life itself as another variable (in addition to the power output MW and the operating temperature T). In such embodiments, the user interface component 408 can allow the user to define a maximum amount of acceptable deviation from the baseline target life (which may be based on a customer service agreement with the equipment manufacturer or other maintenance provider). This user-defined deviation represents a maximum change in the target life that the user considers acceptable. Alternatively, the user may define upper and lower limits on the target life, instructing the dispatch optimization system 402 that the target life for the recommended profile is to remain between these upper and lower boundaries. When the profile generation component 406 performs the iterative analysis described above, rather than terminating the iterative analysis when the estimated FHH is approximately equal to the fixed target life, iterations of the inner and outer loop processing continue until a profit-maximizing operating profile is found having a target life that is within the target life parameters defined by the user. In some embodiments, the profile generation component 406 may generate multiple operating profiles having respective different target lives that are within the acceptable target life range defined by the user, and select the profile that yields the highest profit from among the multiple profiles, thereby allowing the target life to act as a variable together with the power output and operating temperature.

In some embodiments, the computational burden associated with performing multiple iterations of the inner loop processing can be further reduced by parallelizing the computational operations. For example, for a maintenance interval comprising 32,000 hours, the profile generation component 406 may divide the maintenance interval into substantially equal sections (e.g., 32 1000-hour sections, or other suitable segmentations of the maintenance interval) and perform the hourly profit maximization processing for the sections substantially simultaneously using parallel processing. The profit maximization processing can be parallelized in this manner since the inner loop comprises disjoint optimization problems (that is, the solution to the maximization problem for a given hour of the maintenance interval does not depend on maximization solutions found for other hours).

In another example processing scenario, the forecast data 610 can be used to run different instances of the optimization problem to account for variability in data. As an example of this approach, the inner and outer loop processing may be conducted such that only CPL opportunities in the forecast interval are consider in the optimization. Then, each iteration of the outer loop can correspond to a certain optimal peak-fire capability. This can enable the generation of an incremental cost curve as a function of peak-fire hours or MWHr.

The operating profile 606 generated by the dispatch optimization system 402 represents a recommended operating schedule based on forecasted market and environmental data for the maintenance interval. Asset CPL and/or peak-fire operations can be performed in a manner that is informed by the operating profile 606 generated by the dispatch optimization system 402, either by directly exporting the operating profile 606 to an asset control system or by rendering the profile 606 in a report format that can be used as an operating guideline by a plant operator (e.g., via user interface component 408). In most cases, while the forecast data may be a reasonable approximation of future conditions, there is a likelihood that the actual real-world conditions encountered during the maintenance interval will deviate from the forecast data used to generate the operating profile. As such, one or more embodiments of the dispatch optimization system 402 can be configured to re-execute the optimization analysis (the inner and outer loop iterations described above) during operation of the asset within the maintenance interval based on updated market and/or ambient condition data, as well as actual operation of the plant asset.

For example, for embodiments in which the operating profile is exported to a plant asset control system that automatically controls operation (e.g., power output and operating temperature) of the asset in accordance with the operating profile 606, the profile generation component 406 can be configured to re-execute the optimization processing described above either periodically or in response to a defined event. The re-execution can use, as a new target life value, a calculated actual amount of life (FFH) consumed during the maintenance interval thus far subtracted from the original life target. That is, the target life constraint defined for the outer loop processing is the actual amount of remaining life for the maintenance interval, defined as the difference between the original target life (e.g., 32,000 hours) and the calculated amount of life already consumed during the maintenance interval (which can be determined based on the actual operating output MW and temperature T for each previous hour of the maintenance interval together with the parts-life model for the assets). The re-execution can also use any available up-to-date forecast data for the remaining hours of the maintenance interval.

Based on this updated information, the dispatch optimization system 402 will re-execute the inner and outer loop processing described above to yield an updated operating profile 606 for the remaining hours of the maintenance interval. This updated operating profile 606 can be exported to the plant asset control system, or rendered graphically to the user via user interface component 408.

Embodiments of the dispatch optimization system 402 described herein can identify optimal peak-fire and CPL operation opportunities determined to substantially maximize profit generated by one or more plant assets over a maintenance interval, thereby allowing plant operators to utilize the full value potential of their plant assets while satisfying target life requirements. The techniques implemented by the dispatch optimization system 402 allow these substantially optimized operating profiles to be calculated with relatively low computational overhead despite long operating horizons over which the optimization problem must be run.

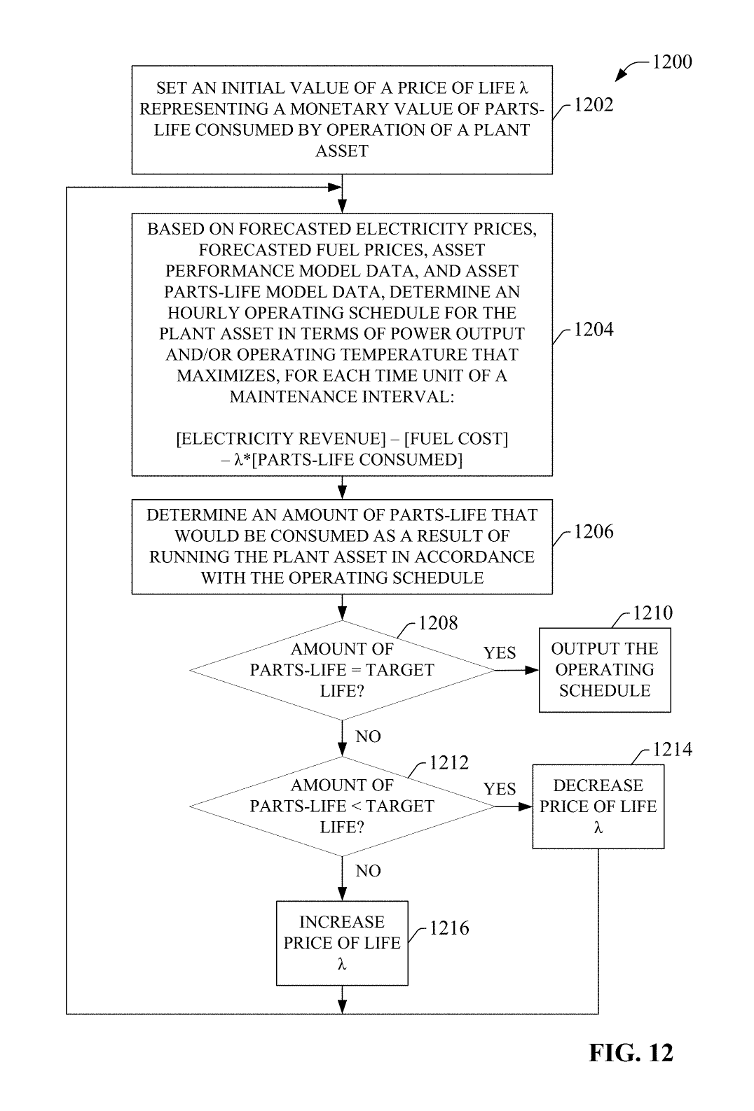

FIG. 12 illustrates a methodology in accordance with one or more embodiments of the subject application. While, for purposes of simplicity of explanation, the one or more methodologies shown herein are shown and described as a series of acts, it is to be understood and appreciated that the subject innovation is not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation. Furthermore, interaction diagram(s) may represent methodologies, or methods, in accordance with the subject disclosure when disparate entities enact disparate portions of the methodologies. Further yet, two or more of the disclosed example methods can be implemented in combination with each other, to accomplish one or more features or advantages described herein.

FIG. 12 illustrates an example methodology 1200 for generating a profit-maximizing operating schedule or profile for a plant asset. Initially, at 1202, an initial value of a price of life λ is set, where the price of life λ represents a monetary value of parts-life consumed by operation of a plant asset (e.g., one or more gas turbines or other power-generating plant assets). At 1204, based on forecasted electricity prices, forecasted fuel prices, performance model data for the plant asset, and parts-life model data for the plant asset, an hourly operating schedule for the plant asset is determined in terms of power output and/or operating temperature (and/or other operating variables) that substantially maximizes, for each time unit of a maintenance interval, a profit value given by

[Electricity Revenue]−[Fuel Cost]−λ*[Parts-Life Consumed]

For scenarios in which the operating schedule is to be found in terms of both plant output MW and operating temperature T, the profit to be maximized for each time unit can be given by equation (2) above. However, if the operating schedule is to be found in terms of other variables, other suitable profit calculations formulas defined in terms of such other variables can be used. In all cases, the profit calculation considers the cost of parts-life consumed (the product of the price of life value λ and the calculated amount of parts-life consumed as a function of the operating variables). Step 1204, which can be considered an inner loop of an overall iterative problem solving process, may require multiple iterations to find the maximum profit for each time unit of the maintenance interval, depending on the number of operating variables (e.g., power output MW, operating temperature T, etc.) that are to be defined in the operating schedule.

At 1206, an amount of parts-life that would be consumed as a result of running the plant asset in accordance with the operating schedule obtained in step 1204 is determined. The parts-life that would be consumed can be determined, for example, based on parts-life model data for the plant asset, which defines the estimated amount of parts-life consumed by the asset as a function of power output MW and/or operating temperature T (or other operating variables).

At 1208 a determination is made as to whether the amount of consumed parts-life calculated at step 1206 is equal to a target life for the asset (within a defined tolerance). If the amount of parts-life does not equal the target life 1208 (NO at step 1208), the methodology proceeds to step 1212, where a determination is made as to whether the amount of parts-life determined at step 1206 is less than the target life. If the amount of parts-life is less than the target life (YES at step 1212), the methodology proceeds to step 1214, where the price of life value λ is increased. Alternatively, if the amount of parts-life is not less than the target life (NO at step 1212), the methodology proceeds to step 1216, where the price of life value λ is increased. After either decreasing or increasing the price of life value λ at steps 1214 or 1216, respectively, the methodology returns to step 1204, and another operating schedule is determined using the updated value of the price of life λ. Steps 1206, 1208, 1212, 1214, and 1216 can be considered an outer loop of the overall iterative schedule determination process.

Steps 1204, 1206, 1208, 1212, 1214, and 1216 are repeated until a determination is made at step 1208 that the amount of parts-life is equal to the target life (within the defined tolerance). When the amount of parts-life is equal to the target life (YES at step 1208), the methodology proceeds to step 1210, where the most recent operating schedule determined at step 1204 is output. In some embodiments, the operating schedule can be output as a report or otherwise rendered in a format that can be reviewed by a user. Alternatively, in some embodiments the operating schedule can be exported to a plant asset control system so that operation of the asset will be controlled in accordance with the schedule.

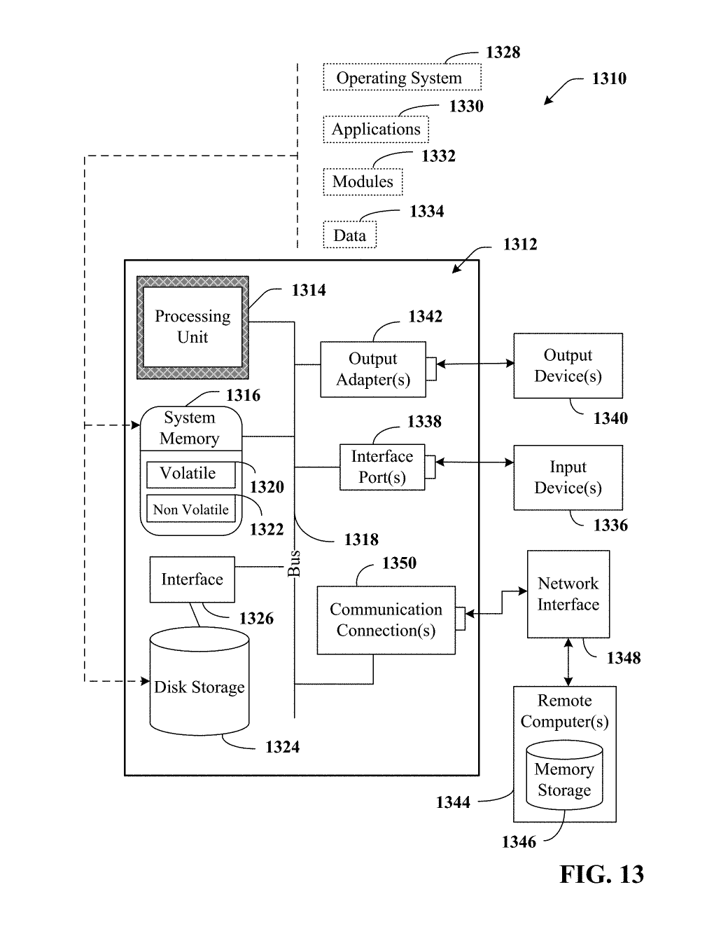

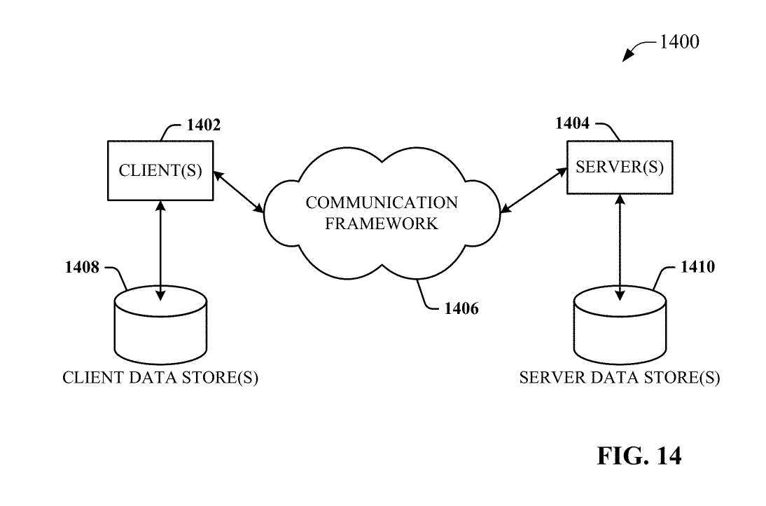

In order to provide a context for the various aspects of the disclosed subject matter, FIGS. 13 and 14 as well as the following discussion are intended to provide a brief, general description of a suitable environment in which the various aspects of the disclosed subject matter may be implemented.

With reference to FIG. 14, an example environment 1310 for implementing various aspects of the aforementioned subject matter includes a computer 1312. The computer 1312 includes a processing unit 1314, a system memory 1316, and a system bus 1318. The system bus 1318 couples system components including, but not limited to, the system memory 1316 to the processing unit 1314. The processing unit 1314 can be any of various available processors. Multi-core microprocessors and other multiprocessor architectures also can be employed as the processing unit 1314.

The system bus 1318 can be any of several types of bus structure(s) including the memory bus or memory controller, a peripheral bus or external bus, and/or a local bus using any variety of available bus architectures including, but not limited to, 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1316 includes volatile memory 1320 and nonvolatile memory 1322. The basic input/output system (BIOS), containing the basic routines to transfer information between elements within the computer 1312, such as during start-up, is stored in nonvolatile memory 1322. By way of illustration, and not limitation, nonvolatile memory 1322 can include read only memory (ROM), programmable ROM (PROM), electrically programmable ROM (EPROM), electrically erasable PROM (EEPROM), or flash memory. Volatile memory 1320 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1312 also includes removable/non-removable, volatile/nonvolatile computer storage media. FIG. 13 illustrates, for example a disk storage 1324. Disk storage 1324 includes, but is not limited to, devices like a magnetic disk drive, floppy disk drive, tape drive, Jaz drive, Zip drive, LS-100 drive, flash memory card, or memory stick. In addition, disk storage 1324 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 1324 to the system bus 1318, a removable or non-removable interface is typically used such as interface 1326.

It is to be appreciated that FIG. 13 describes software that acts as an intermediary between users and the basic computer resources described in suitable operating environment 1310. Such software includes an operating system 1328. Operating system 1328, which can be stored on disk storage 1324, acts to control and allocate resources of the computer 1312. System applications 1330 take advantage of the management of resources by operating system 1328 through program modules 1332 and program data 1334 stored either in system memory 1316 or on disk storage 1324. It is to be appreciated that one or more embodiments of the subject disclosure can be implemented with various operating systems or combinations of operating systems.

A user enters commands or information into the computer 1312 through input device(s) 1336. Input devices 1336 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1314 through the system bus 1318 via interface port(s) 1338. Interface port(s) 1338 include, for example, a serial port, a parallel port, a game port, and a universal serial bus (USB). Output device(s) 1340 use some of the same type of ports as input device(s) 1336. Thus, for example, a USB port may be used to provide input to computer 1312, and to output information from computer 1312 to an output device 1340. Output adapters 1342 are provided to illustrate that there are some output devices 1340 like monitors, speakers, and printers, among other output devices 1340, which require special adapters. The output adapters 1342 include, by way of illustration and not limitation, video and sound cards that provide a means of connection between the output device 1340 and the system bus 1318. It should be noted that other devices and/or systems of devices provide both input and output capabilities such as remote computer(s) 1344.

Computer 1312 can operate in a networked environment using logical connections to one or more remote computers, such as remote computer(s) 1344. The remote computer(s) 1344 can be a personal computer, a server, a router, a network PC, a workstation, a microprocessor based appliance, a peer device or other common network node and the like, and typically includes many or all of the elements described relative to computer 1312. For purposes of brevity, only a memory storage device 1346 is illustrated with remote computer(s) 1344. Remote computer(s) 1344 is logically connected to computer 1312 through a network interface 1348 and then physically connected via communication connection 1350. Network interface 1348 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1350 refers to the hardware/software employed to connect the network interface 1348 to the system bus 1318. While communication connection 1350 is shown for illustrative clarity inside computer 1312, it can also be external to computer 1312. The hardware/software necessary for connection to the network interface 1348 includes, for exemplary purposes only, internal and external technologies such as, modems including regular telephone grade modems, cable modems and DSL modems, ISDN adapters, and Ethernet cards.

FIG. 14 is a schematic block diagram of a sample computing environment 1400 with which the disclosed subject matter can interact. The sample computing environment 1400 includes one or more client(s) 1402. The client(s) 1402 can be hardware and/or software (e.g., threads, processes, computing devices). The sample computing environment 1400 also includes one or more server(s) 1404. The server(s) 1404 can also be hardware and/or software (e.g., threads, processes, computing devices). The servers 1404 can house threads to perform transformations by employing one or more embodiments as described herein, for example. One possible communication between a client 1402 and servers 1404 can be in the form of a data packet adapted to be transmitted between two or more computer processes. The sample computing environment 1400 includes a communication framework 1406 that can be employed to facilitate communications between the client(s) 1402 and the server(s) 1404. The client(s) 1402 are operably connected to one or more client data store(s) 1908 that can be employed to store information local to the client(s) 1402. Similarly, the server(s) 1404 are operably connected to one or more server data store(s) 1410 that can be employed to store information local to the servers 1404.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

What has been described above includes examples of systems and methods illustrative of the disclosed subject matter. It is, of course, not possible to describe every combination of components or methodologies here. One of ordinary skill in the art may recognize that many further combinations and permutations of the claimed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A method, comprising:
selecting, by a system comprising at least one processor, a price of life value representing a cost per unit of consumed parts-life for one or more power-generating plant assets;
determining, by the system for respective time units of a life cycle of the one or more power-generating plant assets, values of one or more operating variables that maximize or substantially maximize profit values based on the price of life value, the one or more operating variables comprising at least one of power output or operating temperature;
determining, by the system, a predicted amount of consumed parts-life over the life cycle for the one or more power-generating plant assets based on the values of the one or more operating variables; and
in response to determining that the predicted amount of consumed parts-life satisfies a defined constraint relative to a target life, generating, by the system, operating profile data for the one or more power-generating plant assets over the life cycle based on the values of the one or more operating variables for the respective time units.

2. The method of claim 1, further comprising:
in response to determining that the predicted amount of consumed parts-life does not satisfy the defined constraint:
modifying, by the system, the price of life value to yield a modified price of life value;
determining, by the system for the for the respective time units based on the modified price of life value, updated values of the one or more operating variables that maximize or substantially maximize the profit values;
determining, by the system, an updated predicted amount of consumed parts-life based on the updated values of the one or more operating variables; and
in response to determining that the updated predicted amount of consumed parts-life satisfies the defined constraint relative to the target life, generating, by the system, the operating profile data for the one or more power-generating plant assets based on the updated values of the one or more operating variables for the respective time units.

3. The method of claim 1, wherein the determining the values of the one or more operating variables that maximize or substantially maximize the profit values comprises determining the values of the one or more operating variables based on forecast data representing at least one predicted ambient condition and at least one predicted market condition for the respective time units of the life cycle.

4. The method of claim 1, further comprising referencing, by the system, model data for the one or more power-generating plant assets to obtain the at least one of the values of the one or more operating variables that maximize or substantially maximize the profit values, wherein
the model data models performance and parts-life consumption for the one or more power-generating plant assets as a function of the one or more operating variables, and
the model data comprises at least one of one or more linear models, one or more nonlinear models, or one or more stochastic models.

5. The method of claim 3, wherein
the at least one predicted ambient condition comprises at least one of an ambient temperature, an ambient pressure, or an ambient humidity, and
the at least one predicted market condition comprises at least one of an energy demand, an electricity price, or a fuel price.

6. The method of claim 1, wherein the determining the values of one or more operating variables that maximize or substantially maximize the profit values comprises determining, for each time unit, at least one of a value of the power output or a value of the operating temperature that maximizes or substantially maximizes
ElectricityPrice*MW−FuelCost*FuelUsed(MW,T,Amb)−λ*FHH_Consumed(MW,T, Amb)
where
ElectricityPrice is a forecasted price of power at the time unit,
MW is the value of the power output for the time unit,
FuelCost is a forecasted price of fuel for the time unit,
T is the value of the operating temperature for the time unit,
Amb is at least one value of at least one ambient conditions for the time unit,
FuelUsed(MW, T, Amb) is a forecasted amount of fuel consumed for the time unit as a function of MW, T, and Amb
λ is the price of life value, and
FHH_Consumed(MW, T, Amb) is a forecasted number of factored fired hours that are created or consumed for the time unit as a function of MW, T, and Amb.

7. The method of claim 6, wherein the determining the values of one or more operating variables that maximize or substantially maximize the profit values comprises determining values for FuelUsed(MW, T, Amb) and FHH_Consumed(MW, T, Amb) by referencing stored model data for the one or more power-generating plant assets.

8. The method of claim 7, wherein the referencing comprises referencing an array of pre-calculated values of FuelUsed(MW, T, Amb) and FHH_Consumed(MW, T, Amb) for ranges of MW and T stored in one or more memories for one or more values of Amb.

9. The method of claim 1, wherein the determining the values of one or more operating variables that maximize or substantially maximize profit values based on the price of life value comprises performing the determining for respective different subsets of the time units in parallel.

10. The method of claim 1, further comprising:
setting, by the system, a range of acceptable values for the target life; and
determining, by the system, a value of the target life and values of the one or more operating variables that maximize or substantially maximize profit.

11. A system, comprising:
a memory that stores executable components;
a processor, operatively coupled to the memory, that executes the executable components, the executable components comprising:
a profile generation component configured to:
determine, for respective time units of a maintenance interval for one or more power-generating assets, first values of one or more operating variables that maximize or substantially maximize profit values based on an estimated price of life value representing a cost per unit of consumed parts-life for the one or more power-generating plant assets,
in response to determining that an estimated number of units of parts-life consumed as a result of operating the one or more power-generating plant assets in accordance with the first values of the one or more operating variables satisfies a defined constraint relative to a target life, generate operating schedule data for the one or more power-generating plant assets based on the first values of the one or more operating variables, and
in response to determining that the estimated number of units of parts-life consumed does not satisfy the defined constraint relative to the target life, modify the estimated price of life value to yield a modified price of life value and determine second values of the one or more operating variables that maximize or substantially maximize profit values based on the modified price of life value; and a user interface component configured to render the operating schedule data.

12. The system of claim 11, wherein the one or more operating variables comprise at least one of a power output or an operating temperature of the one or more power-generating plant assets.

13. The system of claim 11, wherein the profile generation component is configured to determine at least one of the first values or the second values of the one or more operating parameters that maximize or substantially maximize the profit values further based on forecast data representing at least one predicted ambient condition and at least one predicted market condition for the respective time units of the maintenance interval.

14. The system of claim 11, wherein the profile generation component is further configured to determine at least one of the first values or the second values of the one or more operating parameters that maximize or substantially maximize the profit values based on model data that models performance and parts-life consumption for the one or more power-generating plant assets as a function of the one or more operating variables.

15. The system of claim 13, wherein
the at least one predicted ambient condition comprises at least one of an energy demand, an ambient temperature, an ambient pressure, or an ambient humidity, and
the at least one predicted market condition comprises at least one of an electricity price or a fuel price.

16. The system of claim 12, wherein the profit generation component is configured to determine, as at least one of the first values or the second values of the one or more operating parameters that maximize or substantially maximize the profit values, values of the one or more operating parameters that maximize or substantially maximize
ElectricityPrice*MW−FuelCost*FuelUsed(MW,T,Amb)−λ*FHH_Consumed(MW,T, Amb)
where
ElectricityPrice is a forecasted price of power at the time unit,
MW is the value of the power output for the time unit,
FuelCost is a forecasted price of fuel at the time unit,
T is the value of the operating temperature for the time unit,
Amb is one or more values of one or more ambient conditions for the time unit,
FuelUsed(MW, T, Amb) is a forecasted amount of fuel consumed for the time unit as a function of MW, T, and Amb,
λ is the price of life value, and
FHH_Consumed(MW, T, Amb) is a forecasted number of factored fired hours that are created or consumed for the time unit as a function of MW, T, and Amb.

17. The system of claim 16, wherein the profile generation component is configured to reference an array of pre-calculated values of FuelUsed(MW, T) and FHH_Consumed(MW, T) stored on the memory for ranges of MW and T in connection with determining the at least one of the first values or the second values of the one or more operating parameters that maximize or substantially maximize the profit values.

18. A non-transitory computer-readable medium having stored thereon executable instructions that, in response to execution, cause a system comprising at least one processor to perform operations, the operations comprising:
selecting a price of life value representing a cost per unit of consumed parts-life for one or more power-generating plant assets;
determining, for respective time units of a life cycle of the one or more power-generating plant assets, values of one or more operating variables that maximize or substantially maximize profit values based on the price of life value, the one or more operating variables comprising at least one of power output or operating temperature;
determining, for the respective time units, predicted numbers of units of parts-life for the one or more power-generating plant assets based on the values of the one or more operating variables;
determining a predicted life of the one or more power-generating plant assets based on at least one of a sum or an integration of the predicted numbers of units of parts-life across the respective time units; and
in response to determining that the predicted life satisfies a defined constraint relative to a target life, generating operating profile data for the one or more power-generating plant assets over the maintenance duration based on the values of the one or more operating variables for the respective time units.

19. The non-transitory computer-readable medium of claim 18, wherein the operations further comprise:
in response to determining that the predicted life does not satisfy the defined constraint:
modifying, by the system, the price of life value to yield a modified price of life value;
determining, by the system for the for the respective time units based on the modified price of life value, updated values of the one or more operating variables that maximize or substantially maximize the profit values;
determining, by the system for the respective time units, updated predicted numbers of units of parts-life based on the updated values of the one or more operating variables;
determining, by the system, an updated predicted life of the one or more power-generating plant assets based on at least one of a sum or an integration of the updated predicted number of units of parts-life across the respective time units; and
in response to determining that the updated predicted life satisfies the defined constraint relative to the target life, generating, by the system, the operating profile data for the one or more power-generating plant assets based on the updated values of the one or more operating variables for the respective time units.

20. The non-transitory computer-readable medium of claim 18, the determining the values of the one or more operating variables that maximize or substantially maximize the profit values comprises determining the values of the one or more operating variables based on forecast data representing at least one predicted ambient conditions and at least one predicted market conditions for the respective time units of the life cycle.
